(19) United States
(12) Patent Application Publication
(10) Pub. No.: US 2011/0132746 A1
(43) Pub. Date: Jun. 9, 2011

(54) PRODUCTION LINE

(75) Inventors: SHUN-HO CHEN, Tu-Cheng (TW); DONG-SHENG LIN, Tu-Cheng (TW)

(73) Assignee: HON HAI PRECISION INDUSTRY CO., LTD., Tu-Cheng (TW)

(21) Appl. No.: 12/846,854

(22) Filed: Jul. 30, 2010

(30) Foreign Application Priority Data
Dec. 9, 2009 (CN) 200910311118.5

(51) Int. Cl. C25D 19/00; B23P 19/00

(52) U.S. Cl. 204/194; 29/650

(57) ABSTRACT

A production line includes a number of production units, production equipments and a sliding bracket. The sliding bracket slides between the production units. Each production unit includes at least one base unit which is made in series. The at least one base unit has an enclosure. The sliding bracket and the production equipment are received in the enclosure. The production units are arranged in a configuration such as straight line, U-shaped or rectangular.

### BACKGROUND

1. Technical Field

The present disclosure relates to production lines, and particularly, to a portable/moveable production line.

2. Description of the Related Art

A conventional production line includes a number of production devices connected to each other. Because the market requirements change rapidly, the production line must also be changed as quickly as possible. When the production line is replaced or moved, the production devices must be detached from each other, and then reassembled. This results in a higher cost and is very time consuming to replace or move the production line.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of a first embodiment of a production line which includes a plurality of production units.

FIG. 2 is an isometric view of one production unit shown in FIG. 1.

FIG. 3 is an enlarged view of a circular part III shown in FIG. 2.

FIG. 4 is an isometric view of a transporting state of the production units shown in FIG. 1.

FIG. 5 is a top plane view of a second embodiment of a production line.

### DETAILED DESCRIPTION

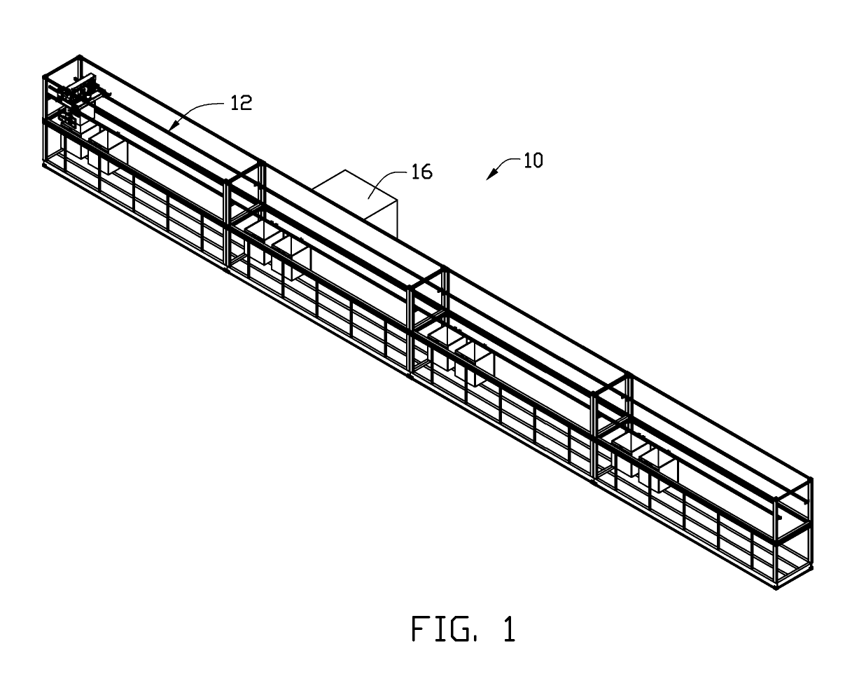

Referring to FIG. 1, a first embodiment of a production line 10 includes a number of production units 12 and a number of production devices or equipments (not shown). The number of the productions units 12 used is decided by a plurality of production requirements. In this embodiment, the production line 10 is an anodizing production line, and includes four production units 12 and a periphery device 16. The four production units 12 are arranged in a straight line. The periphery device 16 is selected from a number of devices that can include, for example, a cooling device, or a mixing device.

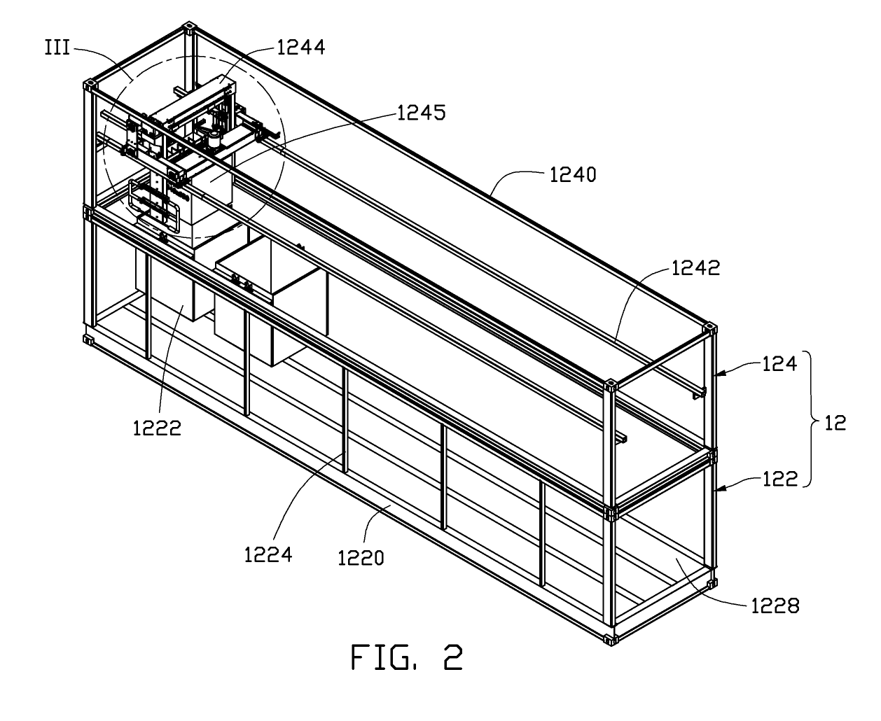

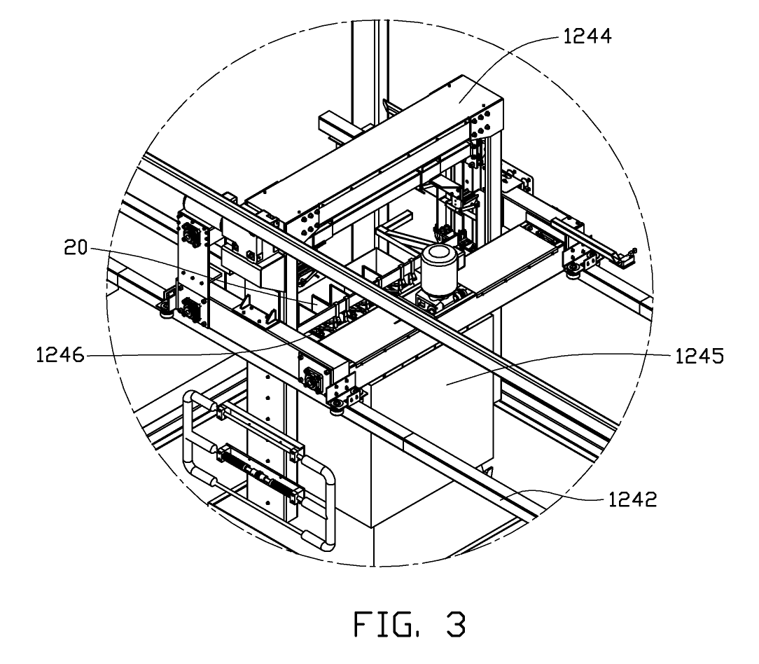

Referring to FIGS. 2 and 3, each production unit 12 includes a first base unit 122 and a second base unit 124. The second base unit 124 is stacked on the first base unit 122. The first base unit 122 and the second base unit 124 are both substantially cuboid in shape. In the illustrated embodiment, the first base unit 122 and the second base unit 124 are a plurality of frames for enclosures, as it is more convenient for transport.

The first base unit 122 and the second base unit 124 can be made in series. In other words, the first base unit 122 and the second base unit 124 are made to be substantially the same size and structure, for assembly for different production lines. For example, the base units can be made in three different models/configurations, namely, A, B, C with each model/configuration having the same size and structure. These different models of the first base unit 122 and the second base unit 124 are assembled to different production lines.

The first base unit 122 includes a first bracket 1220, a number of tanks 1222, a number of reinforcing ribs 1224 and a base plate 1228. In this embodiment, the first bracket 1220 is a frame of an enclosure. The tanks 1220 are fixedly assembled in the bracket 1220. The reinforcing ribs 1224 are fixed onto the first bracket 1220, respectively, to strengthen the stability of the first bracket 1220. The base plate 1228 is fixed on the bottom of the first bracket 1220.

In this embodiment, the first base unit 122 includes a number of tanks 1222 to contain a plurality of different chemical solvents such as, for example, degreasing solvent, water or alkaline solvents.

The second base unit 124 includes a second bracket 1240, two crossbeams 1242, a sliding bracket 1244, a lifting bracket 1245 and a plurality of racks 1246. In this embodiment, the second bracket 1240 is the frame of an enclosure. The two crossbeams 1242 are fixed on the second bracket 1240, and extended along the direction of the length of the second base unit 124. When the production units 12 are connected to each other, the crossbeams 1242 cooperatively form a pair of guide rails. The sliding bracket 1244 is slidably disposed between the two crossbeams 1242, so that the sliding bracket 1244 can slide along a direction along the length of the second base unit 124. The lifting bracket 1245 is disposed on the sliding bracket 1244, and slides along a direction perpendicular to the direction of the length of the second base unit 124. The racks 1246 are hung on the lifting bracket 1245. A plurality of workpieces 20 is fixed to the racks 1246.

The production line 10 is placed in a sealed box, so that the chemical solvents used in the anodizing method are sealed in the sealed box. The sealed box can be supported by the first bracket 1220 and the second bracket 1240, thereby the sealed box does not have a frame.

When the production line 10 is used for anodizing method, the workpieces 20 are fixed to the racks 1246. The tanks 1222 are filled with different chemical solvents used in the anodizing method. The anodizing method includes the following steps:

(a) The sliding bracket 1244 is moved to a first tank 1222. The first tank 1222 is filled with a degreasing solvent. The lifting bracket 1245 is descended into the degreasing solvent, so that the workpieces 20 are immersed in the first tank 1222 to degrease. The lifting bracket 1245 is then ascended after the workpieces 20 are degreased.

(b) The sliding bracket 1244 is moved to a second tank 1222. The second tank 1222 is filled with water. The lifting bracket 1245 is descended into the water, so that the workpieces 20 are immersed in the second tank 1222 to clean.

(c) The sliding bracket 1244 is moved to another tank 1222. The workpieces 20 are processed to receive other treatments.

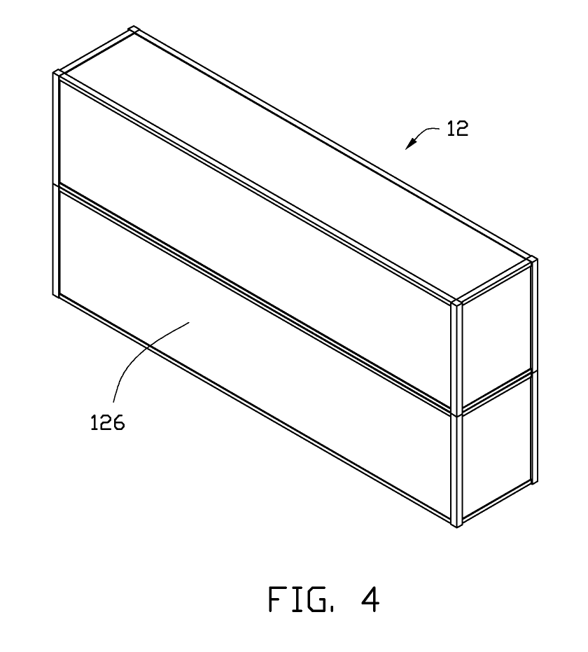

When the production line 10 is being relocated, the first base unit 122 and the second base unit 124 are detached from each other, so that the first base unit 122 and the second base unit 124 are separate enclosures. Referring to FIG. 4, the first base unit 122 and the second base unit 124 further include a plurality of plates 126. The plates 126 are mounted on a bottom surface, two side surfaces and a top surface of the first bracket 1220 and the second bracket 1240, respectively, so that the first base unit 122, the second base unit 124, and the plates 126 cooperatively form a sealed space. The tanks 1222, the sliding bracket 1244, the lifting bracket 1245 and the racks 1246 are placed into the sealed space. Therefore, the production line 10 is moved conveniently, and avoids contamination.

The first base unit 122 and the second base unit 124 are made in series, so that the production line 10 is assembled or disassembled more conveniently. Furthermore, the first base unit 122 and the second base unit 124 are enclosures, for more convenient transportation.

The production line 10 only requires one set of sliding brackets 1244, lifting brackets 1245 and racks 1246, thereby only one second base unit 124 requires to have the sliding brackets 1244, the lifting brackets 1245 and the racks 1246.

It is to be understood that the production line 10 is not limit to be an anodizing procession line, and can also be other types of production or processing lines. The racks 1246 can also be omitted, and instead a clamped structure may be used. The production line 10 is not limited to be arranged in a straight line, and can also be U-shaped, rectangular, or round. The production line 10 can also include a driving device such as a cylinder or a motor. The driving device drives the sliding bracket 1244 to slide or drives the lifting bracket 1245 to move.

It is to be understood that the first base units 122 of the production unit 12 can be fixed to the ground. The second base units 124 of the production unit 12 are fixed to the first base units 122 with a number of fixing structures.

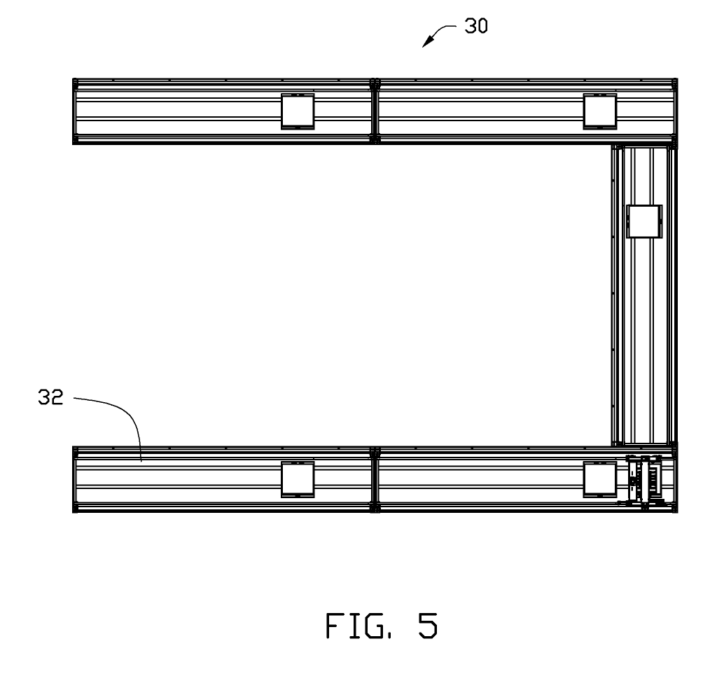

Referring to FIG. 5, a second embodiment of a production line 30 is shown, differing from the first embodiment only in that five production units 32 are arranged in U-shaped configuration.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. A production line comprising:
a production unit comprising at least one base unit, the at least one base units are made in series, and comprising an enclosure and a plurality of production devices assembled into the enclosure.

2. The production line of claim 1, wherein the at least base unit comprises a first base unit and a second base unit, and the second base unit is stacked on the first base unit.

3. The production line of claim 2, wherein the production line is an anodizing processing line.

4. The production line of claim 2, wherein the first base unit comprises a first bracket and at least one tank fixedly assembled in the bracket.

5. The production line of claim 2, wherein the second base unit comprises a second bracket, two crossbeams fixed on the second bracket, a sliding bracket slidably disposed between the two crossbeams, a lifting bracket disposed on the sliding bracket and a plurality of racks hung on the lifting bracket.

6. The production line of claim 4, wherein the at least one tank contains a plurality of different chemical solvents.

7. The production line of claim 4, wherein each of the first base unit and the second base unit further comprises a plurality of plates mounted on a bottom surface, two side surfaces and a top surface of the first bracket and the second bracket, respectively.

8. The production line of claim 4, wherein the first base unit is detachably fixed to the second base unit.

9. The production line of claim 1, wherein each of the at least one base unit has the same size and structure.

10. The production line of claim 7, wherein the at least one base unit is a sealed space.

11. A production line comprising:
a plurality of production units;
a plurality of production equipments;
a sliding bracket sliding between the production units, wherein each production unit comprises at least one base unit made in series, the at least one base unit defines an enclosure, the sliding bracket and the production equipments are received in the enclosure.

12. The production line of claim 11, wherein the at least base unit comprises a first base unit and a second base unit, the second base unit is stacked on the first base unit.

13. The production line of claim 12, wherein the production line is an anodizing processing line.

14. The production line of claim 12, wherein the first base unit comprises a first bracket and at least one tank fixedly assembled in the bracket.

15. The production line of claim 12, wherein the second base unit comprises a second bracket, two crossbeams fixed on the second bracket, a sliding bracket slidably disposed between the two crossbeams, a lifting bracket disposed on the sliding bracket and a plurality of racks hung on the lifting bracket.

16. The production line of claim 14, wherein the at least one tank contains a plurality of different chemical solvents.

17. The production line of claim 14, wherein the first base unit and the second base unit further include a plurality of plates mounted on a bottom surface, two side surfaces and a top surface of the first bracket and the second bracket, respectively.

18. The production line of claim 14, wherein the first base unit is detachably fixed to the second base unit.

19. The production line of claim 17, wherein the at least one base unit is a sealed space.

20. The production line of claim 11, wherein the production units are arranged in a configuration selected from a group consisting of straight line, U-shaped or rectangular.
